(19) United States
(12) Patent Application Publication
(10) Pub. No.: US 2010/0176536 A1
(43) Pub. Date: Jul. 15, 2010

(54) MOLDING APPARATUS AND METHOD

(76) Inventors: Kyo Yang PARK, Gyeyang-gu (KR); Byung Chan YOO, Bucheon-si (KR)

Correspondence Address: North Star Intellectual Property Law, PC, P.O. Box 34688, Washington, DC, 20043, US

(21) Appl. No.: 12/427,779

(22) Filed: Apr. 22, 2009

(30) Foreign Application Priority Data
Jan. 13, 2009 (KR) 10-2009-0002718

(51) Int. Cl. B29C 43/52

(52) U.S. Cl. 264/313; 425/116

(57) ABSTRACT

Disclosed are an apparatus and method for molding an object. An object is compressed by an upper mold and a lower mold base part to form a top surface of a product, and the upper mold and the lower mold base part descend in a state where the object is compressed to form a lateral surface of the product through lateral surfaces of the upper mold and a lower mold.

### CROSS-REFERENCE TO RELATED APPLICATION(S)

This application claims the benefit under 35 U.S.C. §119(a) of a Korean Patent Application No. 10-2009-0002718, filed on Jan. 13, 2009, the disclosure of which is incorporated herein by reference in its entirety.

### TECHNICAL FIELD

The following disclosure relates to an apparatus and method of molding an object such as a plastic or film in a predetermined shape.

### BACKGROUND

With the wide use of an in-molding labeling (IML) method, there has been an increasing demand for cases or packages formed of a plastic or film for various products.

Generally, IML products are produced through a process including a film formation process, a printing process to print contents, a film molding process, and a cutting process to cut out a predetermined portion.

Various methods exist for the molding process including a compression molding method using a mold.

FIG. 1 shows a conventional molding apparatus 100.

The molding apparatus 100 includes an upper mold 103 vertically moved by a mold support 101 and a lower mold 109 disposed on a mold platform 111.

The molding apparatus 100 may mold objects formed of various materials and having various shapes. An operation of the molding apparatus 100 will described with respect to a film as an example of the molding object.

An outer region of a film 102 is fixed by the lower mold 109 and a film fixing part 107. A support 105 vertically moves the film fixing part 107 to carry out the molded film or load a target film 102 to be molded.

When the film 102 to be molded is fixed, the upper mold 103 descends by the mold support 101.

The upper mold 103 may be heated at a predetermined temperature, and the heated upper mold 103 applies a pressure to the film 102 to deform the film 102.

As the upper mold 103 descends, a peripheral region of the film 102 is curved. As a result, a lateral surface of the product is formed between a lateral portion of the lower mold 109 and a lateral portion of the upper mold 103.

If the upper mold 103 descends too quickly, a portion of the film 102 to be deformed may be broken or torn. Thus, the upper mold 103 descends slowly.

As the upper mold 103 descends slowly, the film 102 is slowly deformed. Thus, in order to prevent the lateral surface of the molded film from being restored, the upper mold 103 descends sufficiently to form the desired product having, for example, a long lateral surface.

To prevent the film from being damaged by thermal deformation, the upper mold 103 does not make contact with the lower mold 109 disposing film therebetween. That is, a film surface molded by the lower mold 103 keeps a predetermined distance from the lower mold 109 to the end.

As described above, when the film is molded using a conventional molding method, the upper mold 103 descends slowly, thereby reducing the operation speed.

In addition, in order to prevent the lateral surface of the molded film from being restored, the lateral surface of the molded film is generally more than two times greater than that of a product to be actually used. Thus, in addition to increase in operation time, regions of the lateral surface that is not used is removed, which increases the waste of a raw material.

Also, since the upper mold, i.e., the film attached to a bottom surface of the upper mold does not contact with the lower mold, configuration of a top surface of the molded product is not fixed. Thus, the quality of the products may suffer.

### SUMMARY

According to one general aspect, there is provided a molding apparatus including an object fixing part, an upper mold and a lower mold. The object fixing part fixes an outer region of a molding object, and the lower mold includes a lower mold base part configured to mold a top surface of the molding object by cooperating with a lower portion of the upper mold, the lower mold base part being moved according to a pressure of the upper mold, and a lower mold lateral part configured to a lateral surface of the molding object by cooperating with a lateral portion of the upper mold.

A surface of the upper mold may be heated to maintain the surface at a constant temperature.

Movements of the upper mold and the lower mold base part may be adjusted by an elastic member disposed in/on the inside or a lower portion of the lower mold base part.

The elastic member may be one of an elastic body, a hydraulic unit, and a pneumatic unit.

The lower mold base part may compress and fix the molding object between the upper mold and the lower mold base part and may be moved according to the pressure of the upper mold.

According to another aspect, there is provided a mold apparatus including upper and lower molds configured to compress and mold a molding object. A portion of the lower mold to compress the molding object between the upper mold and the lower mold descends together with the upper mold as the upper mold descends.

According to still another aspect, there is provided a mold method including fixing an outer region of a molding object, compressing the molding object between a lower portion of the upper mold and a lower mold base part, and descending the upper mold to move the upper mold together with the lower mold base part along a lateral portion of the lower mold.

The mold method may include heating the upper mold before the compressing of the molding object.

The moving of the upper mold may include moving the upper mold and the lower mold base part while the movements of the upper mold and the lower mold base part are adjusted through an elastic member.

The elastic member may be one of an elastic body, a hydraulic unit, and a pneumatic unit.

Other features and aspects will be apparent from the following detailed description, the drawings, and the claims.

### BRIEF DESCRIPTION OF THE DRAWINGS

FIG. 1 is a diagram illustrating a conventional molding apparatus.

FIG. 2 is a diagram illustrating an exemplary molding apparatus.

FIGS. 3A to 3D is a schematic view illustrating an operation sequence of an exemplary molding apparatus.

FIGS. 4A to 4D is a schematic view of an exemplary film deformation process.

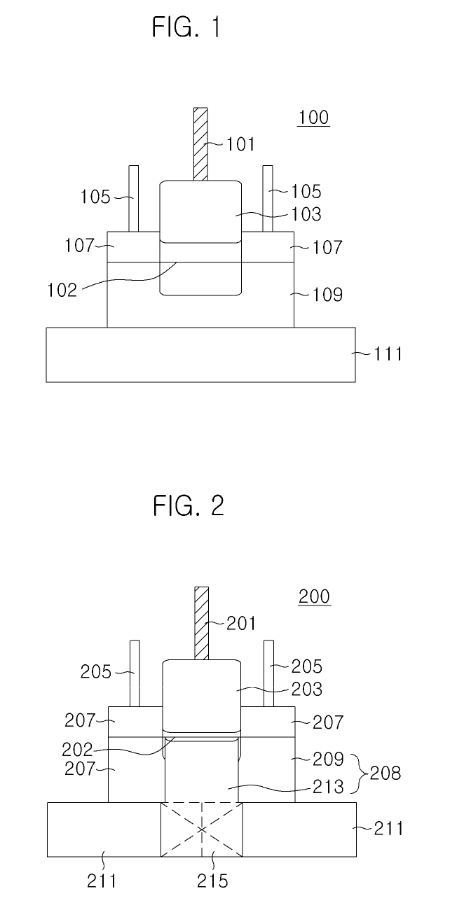

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF EMBODIMENTS

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

Exemplary apparatus and method of compressing an upper mold and a lower mold is described below. According to an exemplary method, an upper mold and a lower mold compress a molding object to form a top surface of a product, then the upper mold descends in a state where the molding object is compressed to mold a lateral surface of the product through lateral surfaces of the upper and lower molds. Accordingly, a yield of the molded product may be improved.

The apparatus and method disclosed herein may be applicable to various molding objects including a film, a plastic material, and various chemical synthesis materials. As an example, a method for molding a film consistent with the disclosures provided herein may be used in various fields such as case manufacturing processes for a digital camera, an MP3 player, a mobile phone, and the like.

In the following description, well-known constructions or functions are omitted for conciseness.

FIG. 2 shows an exemplary molding apparatus 200.

Referring to FIG. 2, an upper mold 203 is vertically moved by a mold support 201, and a lower mold 208 comprises a lower mold lateral part 209 and a lower mold base part 213.

The upper mold 203 may be heated, and a surface temperature of the upper mold 203 may be constantly maintained. A molding object is thermally deformed by the upper mold 203, and thus, is molded.

A film 202, that is, the molding object, is disposed on a top surface of the lower mold lateral part 209, and an outer region of the film 202 is fixed by an object fixing part 207.

The object fixing part 207 is vertically moved by a support 205. When the film 202 to be molded is disposed on a molding position, or the molded film 202 carries out, the object fixing part 207 ascends by the support 205.

When the film 202 to be molded is fixed, the object fixing part 207 descends by the support 205, and the outer region of the film 202 is fixed between the object fixing part 207 and the top surface of the lower mold lateral part 209.

The upper mold 203 descends after the outer region of the film 202 is fixed. As shown in FIG. 2, the lower mold base part 213 is disposed adjacent to the fixed film 202. As the upper mold 203 descends to come into contact with the lower mold base part disposing the film 202 therebetween.

As the upper mold 203 descends further, the lower mold base part 213 descends together with the upper mold 203 along a lateral portion of a mold platform 211.

The movements of the upper mold 203 and the lower mold base part 213 are adjusted by an elastic part 215 disposed on a lower portion of the lower mold base part 213. The elastic part 215 may be disposed in the inside of the lower mold base part 213.

An elastic member is used as the elastic part 215. For example, an elastic body, a hydraulic adjuster, or a pneumatic adjuster may be used as the elastic part 215.

As the film compressed between the upper mold 203 and the lower mold base part 213 descends together with each other, a lateral portion of the film is formed between a lateral portion of the upper mold 203 and the lower mold lateral part 209.

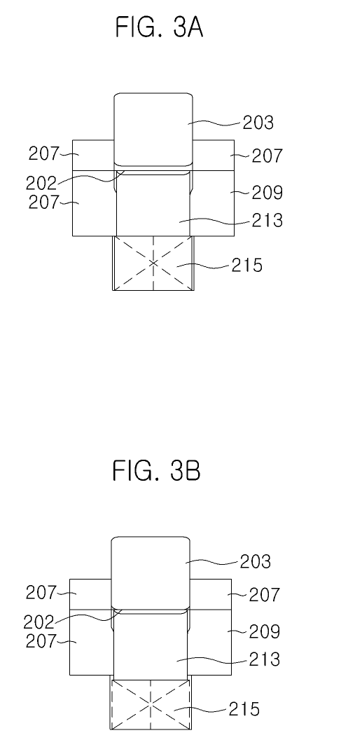

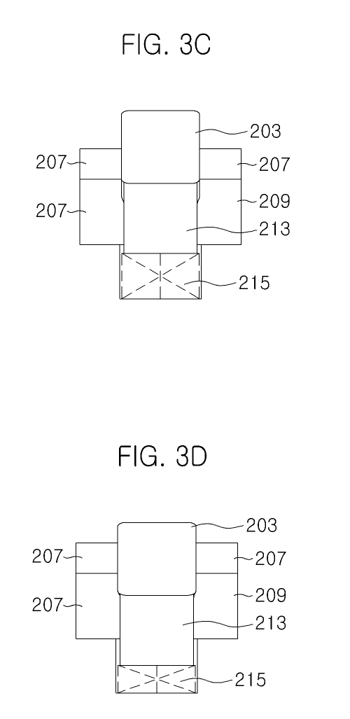

FIGS. 3A to 3D illustrates an operation sequence of an exemplary molding apparatus.

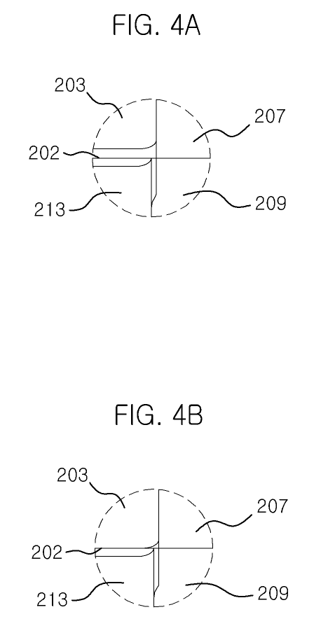

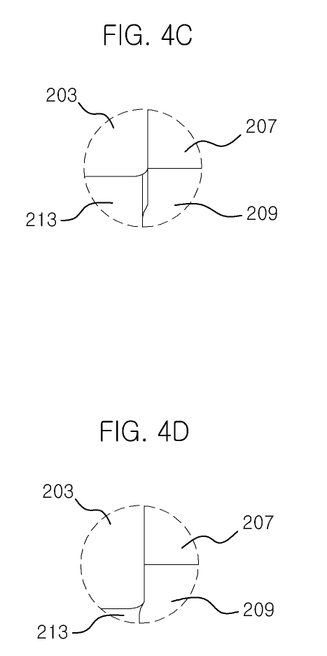

FIGS. 4A to 4D illustrates an exemplary film deformation process.

Referring to FIG. 3A, and more specifically, to FIG. 4A, the fixed film 202 is disposed adjacent to the lower mold base part 213. Thus, when the upper mold 203 descends to contact with the film 202, the film 202 come into contact with the lower mold base part 213.

That is, the film 202 may be in contact with the lower mold 213 before a deformation occurs in a boundary of the film 202 fixed by the object fixing part 207 and the lower mold lateral part 209. Or, as shown in FIG. 3B, the film 202 is in contact with the upper mold 203, and then the upper mold 203 may descend to compress the film by the adjacent lower mold 213 before at least full-scale deformation occurs.

Thus, as shown in FIG. 4B, the film 202 is compressed between the upper mold 203 and the lower mold base part 213 before a boundary between a portion to be compressed between the upper mold 203 and the lower mold base part 213 and a portion fixed between the object fixing part 207 and the lower mold lateral part 209 are deformed in earnest.

When the upper mold 203 is heated at a predetermined temperature, the film is thermally deformed by contacting with the upper mold 203.

Referring to FIGS. 3C and 4C, as the upper mold 203 descends further, the lower mold base part 213 compressing the film 202 disposed between the upper mold 203 and the lower mold base part 213 descends together with the upper mold 203.

The elastic member 215 may be disposed on the lower portion of the lower mold base part 213, or disposed in the inside of the lower mold part 213 to adjust the movement of the lower mold base part 213.

For example, an adjuster using a spring or a hydraulic pressure or an adjuster using a pneumatic pressure may be disposed on the lower portion of the lower mold base part 213 to serve as the elastic member.

According to a pressure applied by the descent of the upper mold 203, the lower mold base part 213 supported by the elastic member 215 may be moved at a buffered speed. Also, the elastic force of the elastic member may be altered to adjust movement distances of the upper mold 203 and the lower mold base part 213.

Accordingly, since the entire movement of the upper mold 203 and the lower mold base part 213 are adjusted and buffered by the elastic member 215, the upper mole 203 may descend at a high pressure and speed.

Also, in a process in which the lateral portion of the molding product is formed by the descent of the upper mold 203, since the film 202 is compressed between the upper mold 203 and the lower mold base part 213 to continuously mold the lateral portion of the film 202, an upper portion of the molding product may be certainly formed.

Thus, the entire molding process may be performed at a shorter time, and the distance of the formed lateral portion may be shorter.

Referring to FIG. 3D, the molding process is progressed, and the upper mold 203 descends by a set time or distance to complete the molding process.

As described above, the descent distance of the upper mold 203 may be set by adjusting the elastic force or a compressive force of the elastic member 215. Referring to FIGS. 4C and 4D, a width of the lower mold lateral part 209 may be adjusted to prevent the upper mold 203 from descending after the upper mold 203 descends by the set distance.

Considering the deformation time or a lateral length of the film 202, the upper mold 203 may descend during the previously set time in consideration of a time at which the film 202 may withstand the thermal deformation, and then, the upper mold 203 may ascend by the mold support 201.

In addition, the descent speed of the upper mold 203 may increase after the upper mold 203 is in contact with the lower mold base part 213, or the descent speed of the upper mold 203 may be constantly maintained before or after the upper mold 203 is in contact with the lower mold base part 213.

According to example(s) described above, a molding apparatus and method may be provided that reduces the molding process time, reduces the raw material waste, and/or improves the yield of the molding process.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A molding apparatus comprising:
an object fixing part;
an upper mold; and
a lower mold,
wherein the object fixing part fixes an outer region of a molding object, and the lower mold comprises:
a lower mold base part configured to mold a top surface of the molding object by cooperating with a lower portion of the upper mold, and move according to a pressure of the upper mold; and
a lower mold lateral part configured to mold a lateral surface of the molding object by cooperating with a lateral portion of the upper mold.

2. The molding apparatus of claim 1, wherein movement of the upper mold and the lower mold base part are adjusted by an elastic member disposed in/on the inside or a lower portion of the lower mold base part.

3. The molding apparatus of claim 2, wherein the elastic member is one of an elastic body, a hydraulic unit, and a pneumatic unit.

4. The molding apparatus of claim 1, wherein a surface of the upper mold is heated to maintain the surface at a constant temperature.

5. The molding apparatus of claim 4, wherein movement of the upper mold and the lower mold base part are adjusted by an elastic member disposed in/on the inside or a lower portion of the lower mold base part.

6. The molding apparatus of claim 5, wherein the elastic member is one of an elastic body, a hydraulic unit, and a pneumatic unit.

7. The molding apparatus of claim 1, wherein the molding object is compressed and fixed between the upper mold and the lower mold base part and the lower mold base part is moved according to the pressure of the upper mold.

8. A mold apparatus comprising:
upper and lower molds configured to compress and mold a molding object,
wherein a portion of the lower mold to compress the molding object between the upper mold and the lower mold descends together with the upper mold as the upper mold descends.

9. A mold method comprising:
fixing an outer region of a molding object;
compressing the molding object between a lower portion of the upper mold and a lower mold base part; and
descending the upper mold to move the upper mold together with the lower mold base part along a lateral portion of the lower mold.

10. The mold method of claim 9, wherein the descending of the upper mold comprises moving the upper mold and the lower mold base part while the movement of the upper mold and the lower mold base part is adjusted through an elastic member.

11. The built-in humidifier of claim 10, wherein the elastic member is one of an elastic body, a hydraulic unit, and a pneumatic unit.

12. The mold method of claim 9, further comprising heating the upper mold before the compressing of the molding object.

13. The mold method of claim 12, wherein the descending of the upper mold comprises moving the upper mold and the lower mold base part while the movement of the upper mold and the lower mold base part is adjusted through an elastic member.

14. The mold method of claim 13, wherein the elastic member is one of an elastic body, a hydraulic unit, and a pneumatic unit.
